(19) United States
(12) Patent Application Publication
(10) Pub. No.: US 2015/0006217 A1
(43) Pub. Date: Jan. 1, 2015

(54) MEETING ORGANIZER

(71) Applicants: Matthias Buehl, Heidelberg (DE); Sylvia Beate Scheu, Sandhausen (DE)

(72) Inventors: Matthias Buehl, Heidelberg (DE); Sylvia Beate Scheu, Sandhausen (DE)

(73) Assignee: SAP AG, Walldorf (DE)

(21) Appl. No.: 13/927,411

(22) Filed: Jun. 26, 2013

(51) Int. Cl. G06Q 10/10

(52) U.S. Cl. CPC G06Q 10/1095
USPC 705/7.19

(57) ABSTRACT

Techniques of organizing meetings are disclosed. Time boundary information and a plurality of participant parameters for a meeting may be received. A priority indication for each participant parameter may also be received. The priority indication may indicate a level of priority of the corresponding participant parameter for the meeting. Different priority indications may indicate different levels of priority. For each participant parameter, at least one potential participant for the meeting may be identified based on the corresponding participant parameter. The priority indication for each participant parameter may be associated with the at least one potential participant corresponding to that participant parameter. For each potential participant, a measure of availability may be determined based on the time boundary information of the meeting. At least one proposed meeting time for the meeting may be determined based on the priority indications and the measures of availability of the potential participants.

### TECHNICAL FIELD

The present application relates generally to the technical field of data processing, and, in various embodiments, to methods and systems of organizing meetings.

### BACKGROUND

Organizing meetings can be difficult and time consuming. Finding a meeting time that works for all meeting participants' schedules often involves much information gathering and decision-making. This process may also be complicated by the fact that certain desired participants or types of participants are more important to the meeting than others.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a network diagram illustrating a client-server system, in accordance with an example embodiment;

FIG. 2 is a block diagram illustrating enterprise applications and services in an enterprise application platform, in accordance with an example embodiment;

FIG. 3 is a block diagram illustrating a meeting organizer system, in accordance with an example embodiment;

FIGS. 4A-4D illustrate a graphical user interface being used to request a meeting proposal, in accordance with example embodiments;

FIG. 5 is a flowchart illustrating a method of organizing a meeting, in accordance with an example embodiment;

FIG. 6 is a flowchart illustrating a method of determining one or more proposed meeting times, in accordance with an example embodiment; and

FIG. 7 is a block diagram of an example computer system on which methodologies described herein may be executed, in accordance with an example embodiment.

### DETAILED DESCRIPTION

Example methods and systems of organizing meetings are described. In the following description, for purposes of explanation, numerous specific details are set forth in order to provide a thorough understanding of example embodiments. It will be evident, however, to one skilled in the art that the present embodiments may be practiced without these specific details.

In some embodiments, a computer-implemented method may comprise receiving time boundary information for a meeting, receiving a plurality of participant parameters for the meeting, and receiving a corresponding priority indication for each participant parameter. The priority indication may indicate a level of priority of the corresponding participant parameter for the meeting. Different priority indications may indicate different levels of priority. For each participant parameter, at least one potential participant for the meeting may be identified based on the corresponding participant parameter. The corresponding priority indication for each participant parameter may be associated with the potential participant(s) corresponding to that participant parameter. For each potential participant, a corresponding measure of availability may be determined based on the time boundary information of the meeting. At least one proposed meeting time for the meeting may be determined based on the associated priority indications of the potential participants and the corresponding measures of availability of the potential participants.

In some embodiments, each participant parameter may comprise an identification of a person or an identification of a role within an organization. In some embodiments, the method may further comprise causing the proposed meeting time(s) to be displayed to a user on a device.

In some embodiments, determining at least one proposed meeting time may comprise receiving a configuration of scoring rules indicating how to score time slots based on the associated priority indications of the potential participants and the corresponding measures of availability of the potential participants, generating scores for the time slots based on an application of the configuration of scoring rules on the associated priority indications of the potential participants and the corresponding measures of availability of the potential participants, ranking the time slots based on their corresponding scores, and selecting either a top portion or a bottom portion of the time slots in the ranked list as the proposed meeting time(s).

In some embodiments, at least one of the participant parameters may comprise an identification of a role within an organization, and, for the at least one of the participant parameters comprising the identification of the role within the organization, identifying the potential participant(s) for the meeting comprises identifying a plurality of potential role-based participants having the role within the organization. In some embodiments, determining at least one proposed meeting time may be further based on a condition of at least one of the potential role-based participants being available to attend the proposed meeting time(s).

In some embodiments, determining at least one proposed meeting time may be further based on a condition of a minimum number of the potential participants being available to attend the at least one proposed meeting time. In some embodiments, determining at least one proposed meeting time may be further based on a condition of a particular grouping of the potential participants being available to attend the at least one proposed meeting time.

In some embodiments, the proposed meeting time(s) may comprise multiple proposed meeting times. In some embodiments, the proposed meeting time(s) may comprise a recurring meeting time. In some embodiments, the proposed meeting time(s) may comprise a date and time slot for the meeting.

In some embodiments, a system may comprise a meeting organizer module on a machine having a memory and at least one processor. The meeting organizer module may be configured to receive time boundary information for a meeting, receive a plurality of participant parameters for the meeting, and receive a corresponding priority indication for each participant parameter. The priority indication may indicate a level of priority of the corresponding participant parameter for the meeting. Different priority indications may indicate different levels of priority. For each participant parameter, at least one potential participant for the meeting may be identified based on the corresponding participant parameter. The corresponding priority indication for each participant parameter may be associated with the potential participant(s) corresponding to that participant parameter. For each potential participant, a corresponding measure of availability may be determined based on the time boundary information of the meeting. At least one proposed meeting time for the meeting may be determined based on the associated priority indications of the potential participants and the corresponding measures of availability of the potential participants.

In some embodiments, each participant parameter may comprise an identification of a person or an identification of a role within an organization. In some embodiments, the meeting organizer module may be further configured to cause the proposed meeting time(s) to be displayed to a user on a device.

In some embodiments, determining at least one proposed meeting time may comprise receiving a configuration of scoring rules indicating how to score time slots based on the associated priority indications of the potential participants and the corresponding measures of availability of the potential participants, generating scores for the time slots based on an application of the configuration of scoring rules on the associated priority indications of the potential participants and the corresponding measures of availability of the potential participants, ranking the time slots based on their corresponding scores, and selecting either a top portion or a bottom portion of the time slots in the ranked list as the proposed meeting time(s).

In some embodiments, at least one of the participant parameters may comprise an identification of a role within an organization, and the meeting organizer module may be further configured to, for the participant parameter(s) comprising the identification of the role within the organization, identify the potential participant(s) for the meeting by identifying a plurality of potential role-based participants having the role within the organization. In some embodiments, determining at least one proposed meeting time is further based on a condition of at least one of the potential role-based participants being available to attend the at least one proposed meeting time.

In some embodiments, determining at least one proposed meeting time may be further based on a condition of a minimum number of the potential participants being available to attend the at least one proposed meeting time. In some embodiments, determining at least one proposed meeting time may be further based on a condition of a particular grouping of the potential participants being available to attend the at least one proposed meeting time.

In some embodiments, the proposed meeting time(s) may comprise multiple proposed meeting times. In some embodiments, the proposed meeting time(s) may comprise a recurring meeting time. In some embodiments, the proposed meeting time(s) may comprise a date and time slot for the meeting.

In some embodiments, a non-transitory machine-readable storage device may store a set of instructions that, when executed by at least one processor, causes the at least one processor to perform the operations and method steps discussed within the present disclosure.

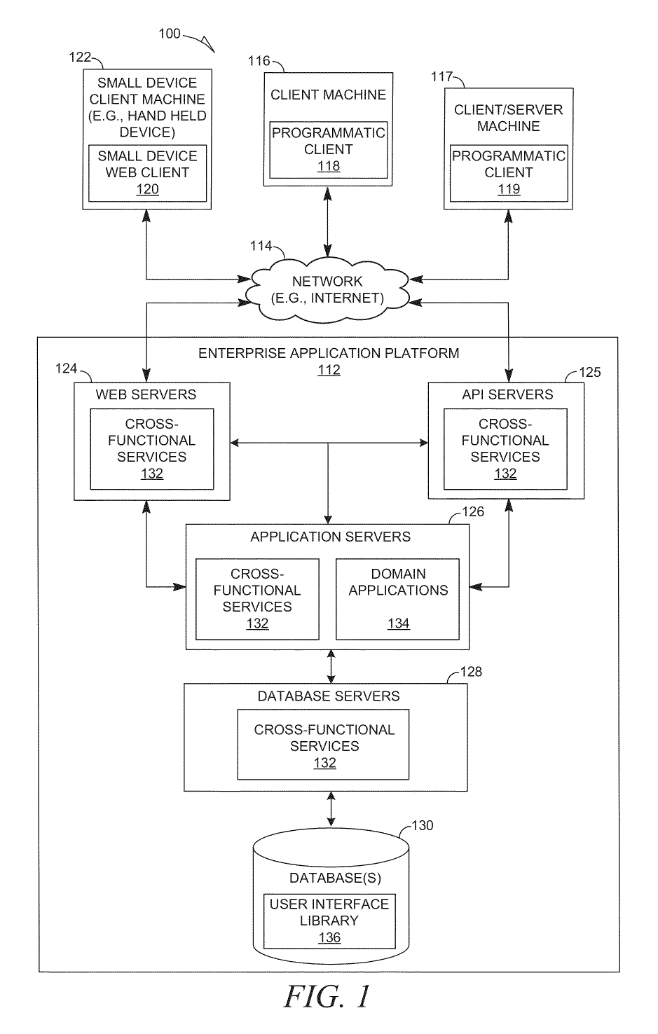

FIG. 1 is a network diagram illustrating a client-server system, in accordance with an example embodiment. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser, such as the INTERNET EXPLORER browser developed by Microsoft Corporation of Redmond, Wash. State), a small device client machine 122 with a small device web client 120 (e.g., a browser without a script engine), and a client/server machine 117 with a programmatic client 119.

Turning specifically to the example enterprise application platform 112, web servers 124 and Application Program Interface (API) servers 125 may be coupled to, and provide web and programmatic interfaces to, application servers 126. The application servers 126 may be, in turn, coupled to one or more database servers 128 that facilitate access to one or more databases 130. The web servers 124, Application Program Interface (API) servers 125, application servers 126, and database servers 128 may host cross-functional services 132. The application servers 126 may further host domain applications 134.

The cross-functional services 132 provide services to users and processes that utilize the enterprise application platform 112. For instance, the cross-functional services 132 may provide portal services (e.g., web services), database services and connectivity to the domain applications 134 for users that operate the client machine 116, the client/server machine 117 and the small device client machine 122. In addition, the cross-functional services 132 may provide an environment for delivering enhancements to existing applications and for integrating third-party and legacy applications with existing cross-functional services 132 and domain applications 134. Further, while the system 100 shown in FIG. 1 employs a client-server architecture, the embodiments of the present invention are of course not limited to such an architecture, and could equally well find application in a distributed, or peer-to-peer, architecture system.

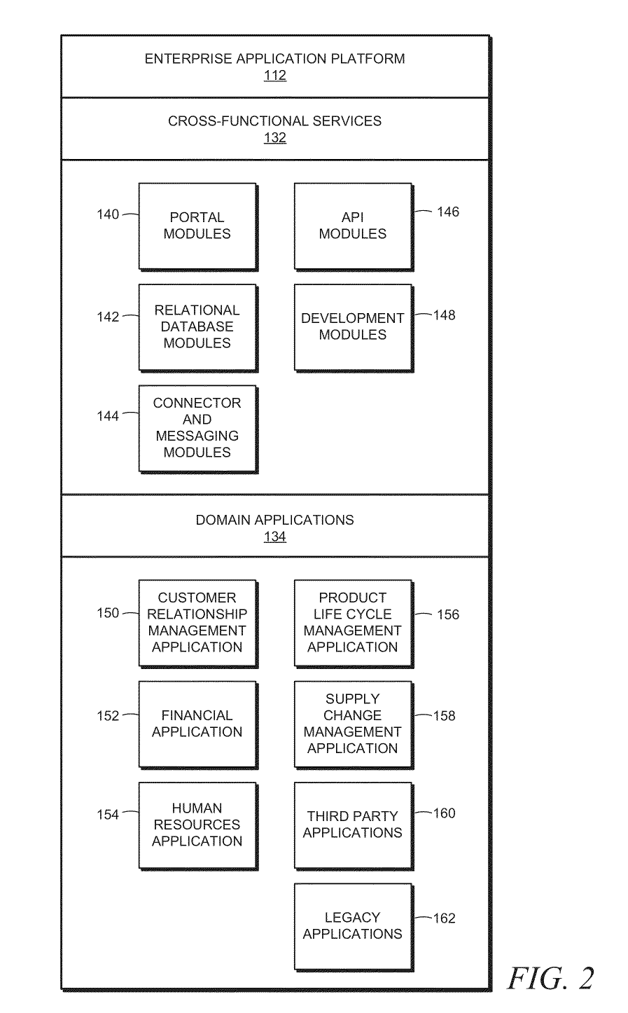

FIG. 2 is a block diagram illustrating enterprise applications and services in an enterprise application platform 112, in accordance with an example embodiment. The enterprise application platform 112 may include cross-functional services 132 and domain applications 134. The cross-functional services 132 may include portal modules 140, relational database modules 142, connector and messaging modules 144, Application Program Interface (API) modules 146, and development modules 148.

The portal modules 140 may enable a single point of access to other cross-functional services 132 and domain applications 134 for the client machine 116, the small device client machine 122, and the client/server machine 117. The portal modules 140 may be utilized to process, author and maintain web pages that present content (e.g., user interface elements and navigational controls) to the user. In addition, the portal modules 140 may enable user roles, a construct that associates a role with a specialized environment that is utilized by a user to execute tasks, utilize services and exchange information with other users and within a defined scope. For example, the role may determine the content that is available to the user and the activities that the user may perform. The portal modules 140 include a generation module, a communication module, a receiving module and a regenerating module. In addition the portal modules 140 may comply with web services standards and/or utilize a variety of Internet technologies including Java, Java 2 Platform Enterprise Edition, SAP's Advanced Business Application Programming Language (ABAP) and Web Dynpro, Extensible Markup Language (XML), Java Cryptography Architecture, Java Authentication and Authorization Service, X.509, Lightweight Directory Access Protocol, Web Service Definition Language, WebSphere Service Registry and Repository, Simple Object Access Protocol, Universal Description Discovery and Integration, and Microsoft.NET.

The relational database modules 142 may provide support services for access to the database(s) 130, which includes a user interface library 136. The relational database modules 142 may provide support for object relational mapping, database independence and distributed computing. The relational database modules 142 may be utilized to add, delete, update and manage database elements. In addition, the relational database modules 142 may comply with database standards and/or utilize a variety of database technologies including Structured Query Language (SQL), Structured Query Language Database Connectivity, Oracle, MySQL, Unicode, Java Database Connectivity.

The connector and messaging modules 144 may enable communication across different types of messaging systems that are utilized by the cross-functional services 132 and the domain applications 134 by providing a common messaging application processing interface. The connector and messaging modules 144 may enable asynchronous communication on the enterprise application platform 112.

The Application Program Interface (API) modules 146 may enable the development of service-based applications by exposing an interface to existing and new applications as services. Repositories may be included in the platform as a central place to find available services when building applications.

The development modules 148 may provide a development environment for the addition, integration, updating and extension of software components on the enterprise application platform 112 without impacting existing cross-functional services 132 and domain applications 134.

Turning to the domain applications 134, the customer relationship management application 150 may enable access to and may facilitate collecting and storing of relevant personalized information from multiple data sources and business processes. Enterprise personnel that are tasked with developing a buyer into a long-term customer may utilize the customer relationship management applications 150 to provide assistance to the buyer throughout a customer engagement cycle.

Enterprise personnel may utilize the financial applications 152 and business processes to track and control financial transactions within the enterprise application platform 112. The financial applications 152 may facilitate the execution of operational, analytical and collaborative tasks that are associated with financial management. Specifically, the financial applications 152 may enable the performance of tasks related to financial accountability, planning, forecasting, and managing the cost of finance.

The human resource applications 154 may be utilized by enterprise personnel and business processes to manage, deploy, and track enterprise personnel. Specifically, the human resource applications 154 may enable the analysis of human resource issues and facilitate human resource decisions based on real time information.

The product life cycle management applications 156 may enable the management of a product throughout the life cycle of the product. For example, the product life cycle management applications 156 may enable collaborative engineering, custom product development, project management, asset management and quality management among business partners.

The supply chain management applications 158 may enable monitoring of performances that are observed in supply chains. The supply chain management applications 158 may facilitate adherence to production plans and on-time delivery of products and services.

The third-party applications 160, as well as legacy applications 162, may be integrated with domain applications 134 and utilize cross-functional services 132 on the enterprise application platform 112.

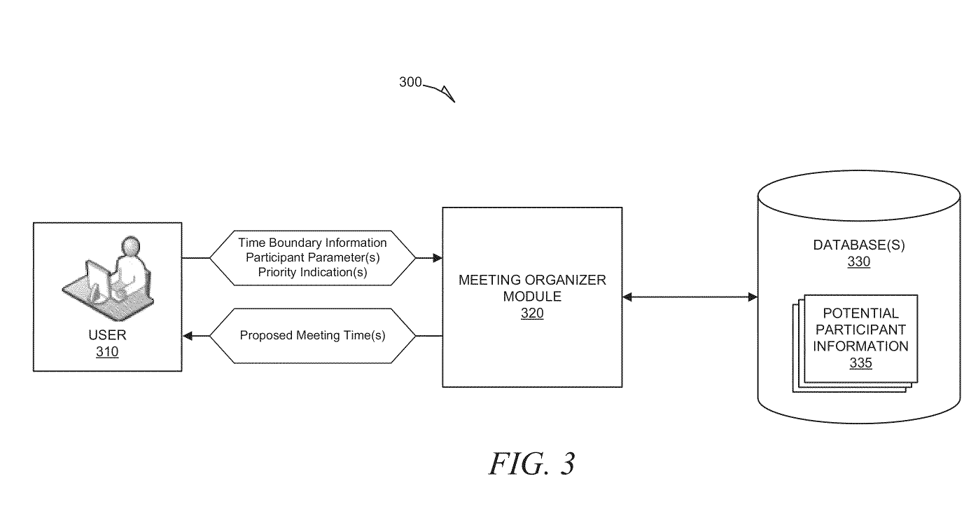

FIG. 3 is a block diagram illustrating a meeting organizer system 300, in accordance with an example embodiment. In some embodiments, the meeting organizer system 300 may comprise a meeting organizer module 320. The meeting organizer module 320 may reside on a machine having a memory and at least one processor (not shown). In some embodiments, the meeting organizer module 320 may be incorporated into the enterprise application platform 112 in FIG. 1 (e.g., on application server(s) 126). However, it is contemplated that other configurations are also within the scope of the present disclosure.

In some embodiments, the meeting organizer module 320 may be configured to determine one or more proposed meeting times for a meeting in response to receiving inputs from a user 310 on a device (e.g., any of machines 116, 117, and 122 in FIG. 1). The inputs may include, but are not limited to, time boundary information for a meeting, a plurality of participant parameters for the meeting, and a corresponding priority indication for each participant parameter.

In some embodiments, the time boundary information may comprise conditions that indicate time restrictions or guidelines on which the user 310 is requesting the proposed meeting time(s) be based. The time boundary information may comprise a variety of temporal data, including, but not limited to, a window of dates (e.g., from May 7, 2013 to May 9, 2013), a window of time (e.g., between 9:00 am and 5:00 pm), and a duration (e.g., 1 hour). The time boundary information may also comprise preferred time slots, blocked time slots (e.g., not between 12:00 pm and 1:00 pm), break duration (e.g., ½ hour lunch break during meeting), a number of meeting recurrences (e.g., 3 meetings), and time slot distribution (e.g., 3 meetings within 4 weeks). For recurring meetings, the user 310 may also request that the meetings always occur at the same time. Additionally, the user 310 may request that the recurring meetings always have the same or have a customized duration for each meeting in the set of recurring meetings (e.g., the first meeting should be 4 hours long, and the two subsequent meetings should each be 2 hours long).

In some embodiments, the each participant parameter is configured to identify, or otherwise indicate, a potential participant (e.g., a person) for the meeting or a grouping of potential participants having a common characteristic. In some embodiments, the common characteristic may be the same role within an organization. For example, the user 310 may request that a platform architect within an organization be a participant in the meeting. Such a request may open up the potential participants to include more than just specific people, but rather types of people as well, thereby providing more flexibility in determining and scheduling meeting times. In the example of the request for a platform architect to attend the meeting, the fact that a particular platform architect within an organization is unavailable at a certain time would not necessarily dictate whether the meeting could be held at that time, since there may be other platform architects within the organization that are available at that time. Information 335 regarding potential participants may be stored in one or more database(s) 330, which may be accessed by the meeting organizer module 320 in determining proposed meeting times. This information 335 may include, but is not limited to, names (or other forms of identification) of people, characteristics (e.g., role within an organization), contact information (e.g., e-mail address), and availability (e.g., calendar schedule). In some embodiments, the database(s) 330 may be incorporated into the database(s) 130 in FIG. 1. However, it is contemplated that other configurations are also within the scope of the present disclosure.

In some embodiments, each priority indication may indicate a level of priority of the corresponding participant parameter for the meeting. Different priority indications may indicate different levels of priority. In one example, the different levels of priority include Key Participant, Mandatory Participant, and Optional Participant. It is contemplated that other levels of priority are also within the scope of the present disclosure. The user 310 may decide which priority level applies to which participants or grouping of participants and provide priority indications accordingly. The corresponding priority indication for each participant parameter may be associated with the potential participant(s) corresponding to that participant parameter. For example, in the scenario discussed above where the user 310 requests that a platform architect attend the meeting, the user 310 may provide an indication that the platform architect is a Key Participant. As a result, the level of priority for all of the potential participants that qualify as a platform architect may be determined to be Key Participant.

For each potential participant, a corresponding measure of availability may be determined based on the time boundary information of the meeting. Examples of measures of availability may include, but are not limited to, Busy or Out-of-the-Office (OoO), Tentative, and Free. A measure of availability equal to Busy or OoO may indicate that the potential participant absolutely cannot attend the meeting for the time boundary information (e.g., within the time boundary provided by the user 310). A measure of availability equal to Tentative may indicate that the potential participant may or may not be free to attend the meeting for the time boundary information. A measure of availability equal to Free may indicate that the potential participant is free to attend the meeting for the time boundary information. The measures of availability of potential participants may be accessed, retrieved, and/or determined from the potential participant information 335 in the database(s) 330. However, it is contemplated that other sources of measures of availability are also within the scope of the present disclosure. In some embodiments, information from a calendar program (e.g., Microsoft Outlook) used by a potential participant may be used to determine his or her measure of availability.

In some embodiments, the meeting organizer module 320 may be configured to determine at least one proposed meeting time for the meeting based on the associated priority indications of the potential participants and the corresponding measures of availability of the potential participants. In some embodiments, the higher the level of priority for a potential participant, the more the availability of that potential participant is valued in determining the proposed meeting time(s). Conversely, the lower the level of priority for a potential participant, the less the availability of that potential participant is valued in determining the proposed meeting time(s). In some embodiments, the availability of a meeting room, as well as other conditions, may also factor into the determination of the proposed meeting time(s).

In some embodiments, the meeting organizer module 320 may generate scores for time slots based on an application of scoring rules on the associated priority indications of the potential participants and the corresponding measures of availability of the potential participants. In some embodiments, the time slots may be restricted based on the time boundary information (e.g., 1 hour slots from 9:00 am to 5:00 pm). The scoring rules may indicate how to score time slots based on the associated priority indications of the potential participants and the corresponding measures of availability of the potential participants. In some embodiments, a default set of scoring rules may be used. In some embodiments, the scoring rules may be configured by the user 310. The meeting organizer module 320 may rank the time slots based on their corresponding scores (e.g., high-to-low or low-to-high). The meeting organizer module 320 may select a portion of the time slots in the ranked list to be the proposed meeting time(s). The selected portion may reflect the prioritization of the availability of the potential participants having a higher level of priority. In one example, the meeting organizer module 320 may select the top two time slots out of thirty time slots or the bottom two time slots out of thirty time slots, depending on whether the prioritization of the availability of the potential participants having a higher level of priority is reflected in the ranking from top-to-bottom or from bottom-to-top.

In some embodiments, other conditions may be used by the meeting organizer module 320 to determine the proposed meeting time(s). The user 310 may provide indications of these other conditions on which he or she desires the proposed meeting time(s) to be based. These other conditions may include, but are not limited to, a specific person being available to attend the meeting, at least one person in a grouping of people (e.g., at least one platform architect) being available to attend the meeting, a particular grouping of the potential participants being available to attend the at least one proposed meeting time, a minimum number or percentage of the potential participants being available to attend the at least one proposed meeting time, and one or more particular meeting rooms being available for the meeting. In some embodiments, these other conditions may be used by the meeting organizer module 320 to influence the ranking of time slots. For example, in some embodiments, the availability of a meeting room may be used to influence the ranking when two time slots have an otherwise equal ranking (e.g., if the measures of availability for the potential participants is the same for both time slots). In some embodiments, if two or more slots have an identical ranking based on the measures of availability for the potential participants, the meeting organizer module 320 may give preference to (e.g., rank higher) the time slot for which a meeting room is available. Preference may be given to a time slot for which any meeting room is available, a particular meeting room is available, and/or at least one of a particular set of meeting rooms is available. It is contemplated that the use of other conditions to determine the proposed meeting time(s) is also within the scope of the present disclosure.

In some embodiments, the proposed meeting time(s) may comprise multiple proposed meeting times. In some embodiments, the proposed meeting time(s) may comprise a recurring meeting time (e.g., every Monday at 10:30 am). In some embodiments, the proposed meeting time(s) may comprise a date and time slot (e.g., May 9, 2013 at 10:30 am) for the meeting.

In some embodiments, the meeting organizer module 320 may be configured to make propositions on how to schedule multiple meetings within a certain period of time. For example, the user 310 may request proposed meeting times for five meetings within four weeks. The meeting organizer module 320 may determine proposed meeting times based on the parameters provided by the user, as previously discussed. Furthermore, the meeting organizer module 320 may also factor in a condition that the multiple meetings be equally distributed or substantially equally distributed (e.g., below maximum amount of variance in gaps between meetings) within the requested period of time. It is contemplated that the meeting organizer module 320 may vary certain characteristics of the multiple proposed meeting times. For example, the meeting duration and location may vary for the five different meetings in the example above. Additionally, the day of the week and the time of day need not be the same for the five different meetings. The meeting organizer module 320 may vary these, and other, characteristics of the multiple meetings depending on the availability of the potential participants.

In some embodiments, the meeting organizer module 320 may be configured to cause the proposed meeting time(s) to be displayed to a user 310 on a device. The user 310 may select a proposed meeting time, or multiple proposed meeting times (if presented). The meeting organizer module 320 may then send an invitation to the meeting to the corresponding potential participants. The invitation may include date, time, and location information, as well as other relevant information.

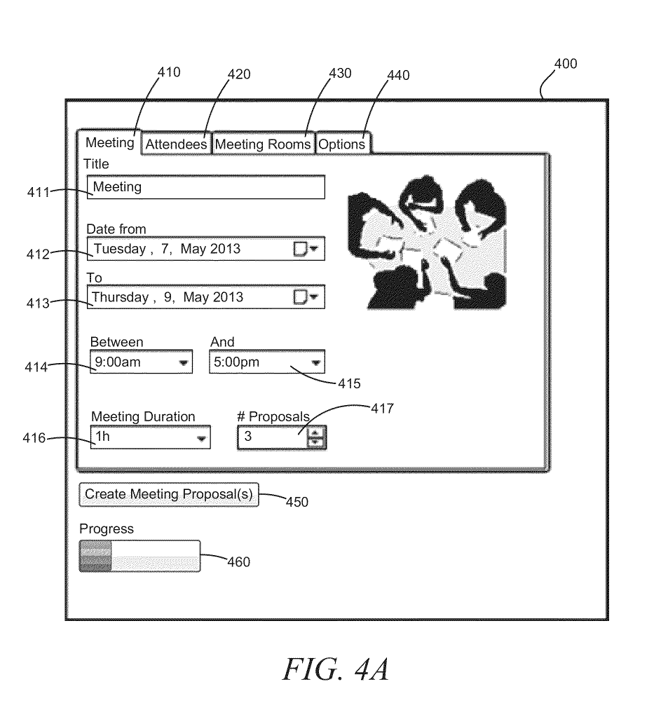

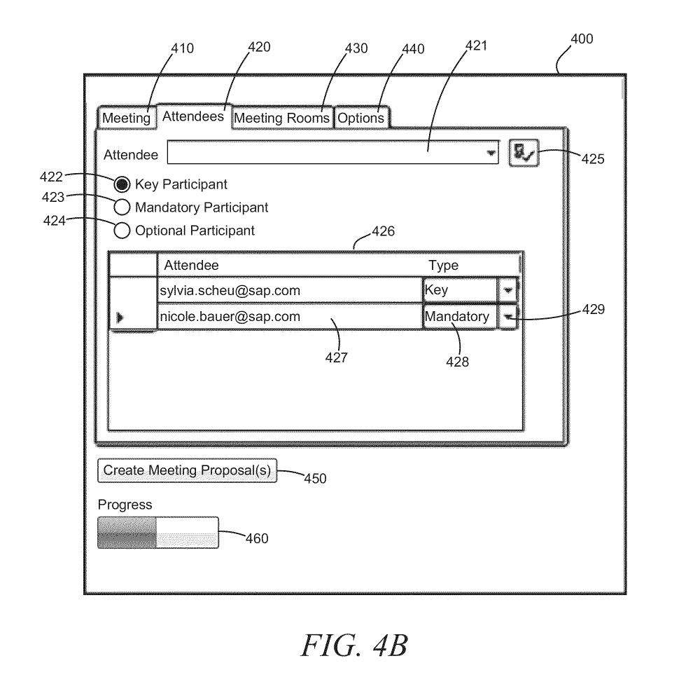

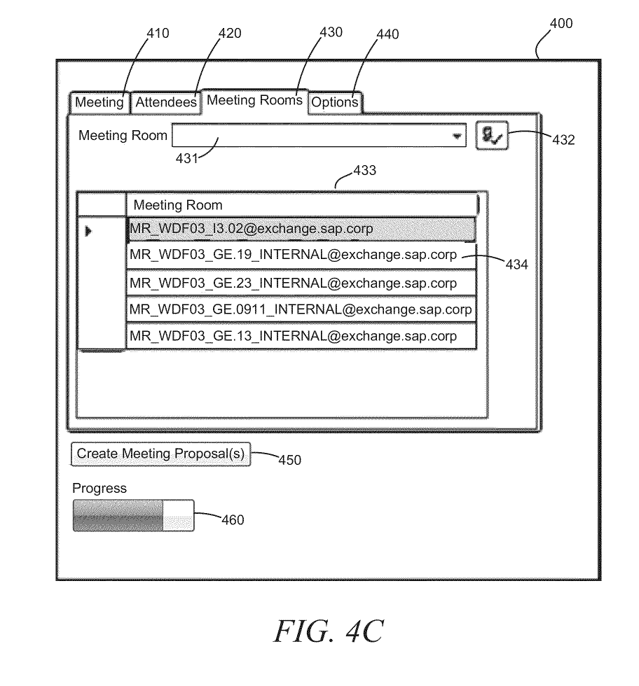

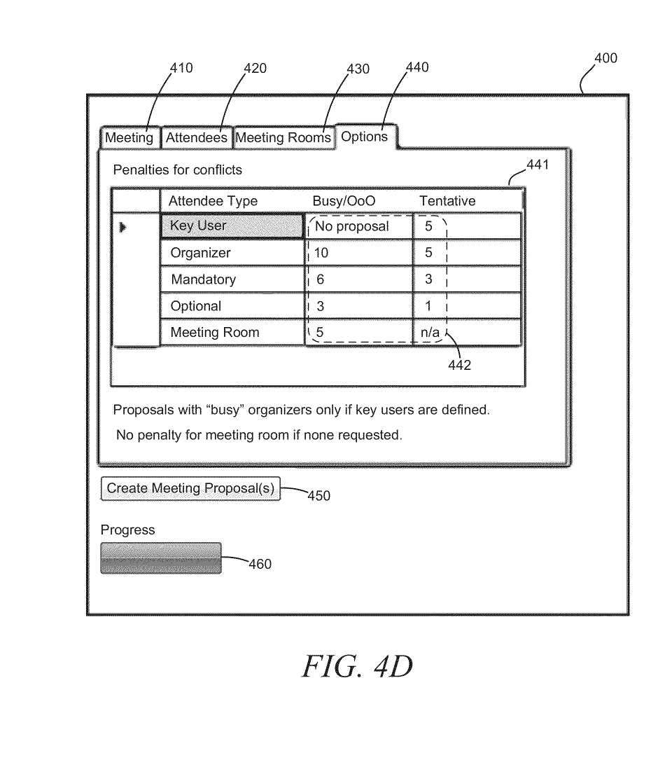

FIGS. 4A-4D illustrate a graphical user interface 400 being used to request a meeting proposal, in accordance with example embodiments. In some embodiments, the graphical user interface 400 is provided by the meeting organizer module 320. In FIGS. 4A-4D, the graphical user interface 400 may comprise a Meeting tab 410, an Attendees tab 420, a Meeting Rooms tab 430, and an Options tab 440. It is contemplated that other tab configurations are also within the scope of the present disclosure.

In FIG. 4A, the Meeting tab 410 is brought to the forefront. Several graphical user interface elements may be provided to enable the user 310 to provide input regarding the meeting. Such graphical user interface elements may include, but are not limited to, text boxes, radio buttons, drop-down lists, list boxes, and check boxes. It is contemplated that other graphical user interface elements are also within the scope of the present disclosure. A Title field 411 may be provided to enable the user 310 to enter a name for the meeting proposal(s) being requested. One or more time boundary information fields may be provided to enable the user 310 to provide time boundary information, which may be used by the meeting organizer module 320 to determine the proposed meeting time(s). Such time boundary information fields may include, but are not limited to, a first date boundary field 412, a second date boundary field 413, a first time boundary field 414, a second time boundary field 415, and a duration field 416. It is contemplated that other time boundary information fields are also within the scope of the present disclosure.

The first date boundary field 412 and the second date boundary field 413 may enable the user 310 to provide a window of dates within which the meeting is preferred. For example, the user 310 may provide input indicating that the meeting should take place sometime from May 7, 2013 to May 9, 2013. The first time boundary field 414 and the second time boundary field 415 may enable the user 310 to provide a window of times within which the meeting is preferred. For example, the user 310 may provide input indicating that the meeting should take place sometime between 9:00 am and 5:00 pm. The duration field 416 may enable the user 310 to provide a length of time for which the meeting is preferred to last. For example, the user 310 may provide input indicating that the meeting should last one hour.

The graphical user interface 400 may also provide a proposal quantity field 417, which may enable the user 310 to provide the number of meeting time proposals that he or she is requesting. For example, if the user 310 would like to be provided three different meeting time proposals, he or she may provide input indicating such a request.

The graphical user interface 400 may also provide a progress bar 460. The progress bar 460 may be configured to indicate how far along the user 310 is in the process of requesting the meeting time proposal(s). Such an indication may be based on how much information the user 310 has provided as input for the determination of the meeting time proposal(s).

A request submission button 450 may be provided by the graphical user interface 400 to enable the user 310 to submit his or her input and prompt the determination of the meeting time proposal(s). In some embodiments, the user 310 may select the request submission button 450 at any time during the process. In some embodiments, default values for user input may be employed by the meeting organizer module 310 in order to compensate for a lack of user input regarding information upon which the determination of the meeting time proposal(s) is to be based. For example, if the user does not provide any input for the first time boundary field 414 and the second time boundary field 415, the meeting organizer module 320 may use default values of 10:00 am and 4:00 pm, respectively. It is contemplated that other default configurations are also within the scope of the present disclosure.

In FIG. 4B, the Attendees tab 420 is brought to the forefront. Here, several graphical user interface elements may be provided to enable the user 310 to provide input regarding participant parameters for the meeting. An attendee field 421 may be provided to enable the user 310 to select a participant parameter. As previously discussed, the participant parameter may identify, or otherwise indicate, a specific person or a grouping of people having a common characteristic (e.g., a role within an organization). The user 310 may provide an indication of a participant parameter in the attendee field 421. In some embodiments, the user 310 may select a participant parameter from a drop-down menu, which may be populated with participant parameters by the meeting organizer module 320 using information from the database(s) 330. However, it is contemplated that other implementations of the attendee field 421 are also within the scope of the present disclosure.

In some embodiments, the graphical user interface 400 may provide selectable elements to enable the user to assign an indication of a level of priority to the participant parameter in the attendee field 421. For example, the user 310 may select a Key Participant radio button 422 to assign a high level of priority to the participant parameter, a Mandatory Participant radio button 423 to assign a medium level of priority to the participant parameter, and an Optional Participant radio button 424 to assign a low level of priority to the participant parameter. However it is contemplated that other levels of priority and implementations of their selection are also within the scope of the present disclosure.

The user 310 may click, or otherwise activate, a confirmation button 425 to confirm the selection of the participant parameter and level of priority. Upon confirmation, the selection may be reflected in a table 426. The table 426 may display all of the participant parameters 427 selected by the user 310 and their corresponding level of priorities 428. The user 310 may change the level of priority 428 of a participant parameter 427 using a user interface element on the table 426, such as a drop-down menu 429. It is contemplated that the level of priority 428 of a participant parameter 427 may be changed in other ways as well.

In FIG. 4C, the Meeting Rooms tab 430 is brought to the forefront. Here, several graphical user interface elements may be provided to enable the user 310 to provide input regarding potential meeting rooms for the meeting. A meeting room field 431 may be provided to enable the user 310 to select a meeting room. The meeting room may identify, or otherwise indicate, a specific room in a building or some other location. In some embodiments, the user 310 may select a meeting room from a drop-down menu, which may be populated with meeting rooms by the meeting organizer module 320 using information from the database(s) 330. However, it is contemplated that other implementations of the meeting room field 431 are also within the scope of the present disclosure. The user 310 may click, or otherwise activate, a confirmation button 432 to confirm the selection of the meeting room selected in the meeting room field 431. Upon confirmation, the selection may be reflected in a table 433. The table 433 may display all of the meeting room indications 434 selected by the user 310.

In FIG. 4D, the Options tab 440 is brought to the forefront. Here, several graphical user interface elements may be provided to enable the user 310 to provide input to configure scoring rules for generating scores for time slots, which may then be ranked based on the generated scores. A scoring rules table 441 may be provided to enable the user 310 to input elements 442 of the scoring rules. These rules may define how the measure of availability of the potential participants and their corresponding levels of priority affect the scoring of the time slots. The rules may also define how the measure of availability of a meeting room affects the scoring of the time slots.

In one example shown in FIG. 4D, the elements 442 of the scoring rules comprise penalties to be applied to the score of a time slot if the availability of a potential participant conflicts with the time slot, as well as penalties to be applied to the score of a time slot if the availability of a meeting room conflicts with the time slot. In this example, a time slot is penalized more (i.e., less likely to be selected) when potential participants having a high level of priority have a low measure of availability for the time slot. However, other configurations are also within the scope of the present disclosure. The measures of availability of the potential participants and the meeting rooms may be obtained from one or more calendar programs or databases 330.

In the example shown in FIG. 4D, if any of the potential participants having a Key User level of priority have a measure of availability equal to Busy or Out-of-the-Office, then the time slot may be blocked from any chance of being proposed as a meeting time. If any of the potential participants having a Key User level of priority have a measure of availability equal to Tentative, then the time slot may be penalized 5 points. If any of the potential participants having an Organizer level of priority have a measure of availability equal to Busy or Out-of-the-Office, then the time slot may be penalized 10 points. If any of the potential participants having an Organizer level of priority have a measure of availability equal to Tentative, then the time slot may be penalized 5 points. If any of the potential participants having a Mandatory level of priority have a measure of availability equal to Busy or Out-of-the-Office, then the time slot may be penalized 6 points. If any of the potential participants having a Mandatory level of priority have a measure of availability equal to Tentative, then the time slot may be penalized 3 points. If any of the potential participants having an Optional level of priority have a measure of availability equal to Busy or Out-of-the-Office, then the time slot may be penalized 3 points. If any of the potential participants having an Optional level of priority have a measure of availability equal to Tentative, then the time slot may be penalized 1 point. If a desired meeting room has a measure of availability for the time slot equal to Busy or Out-of-the-Office, then the time slot may be penalized 5 points. If the desired meeting room has a measure of availability equal to Tentative, then no penalty is applied.

The penalties may be applied in a variety of ways. For example, if the time slots are to be ranked from high scores to low scores (e.g., highest score ranked #1, second highest score ranked #2, etc.) with the highest ranked time slots (e.g., the #1 and #2 ranked time slots) being most likely to be selected as meeting time proposals, then the penalties may be negative or subtracted points. In another example, if the time slots are to be ranked from low scores to high scores (e.g., lowest score ranked #1, second lowest score ranked #2, etc.) with the highest ranked time slots (e.g., the #1 and #2 ranked time slots) being most likely to be selected as meeting time proposals, then the penalties may be positive or added points. It is contemplated that configurations of penalties, scoring, ranking, and time slot selection other than those shown or described are also within the scope of the present disclosure.

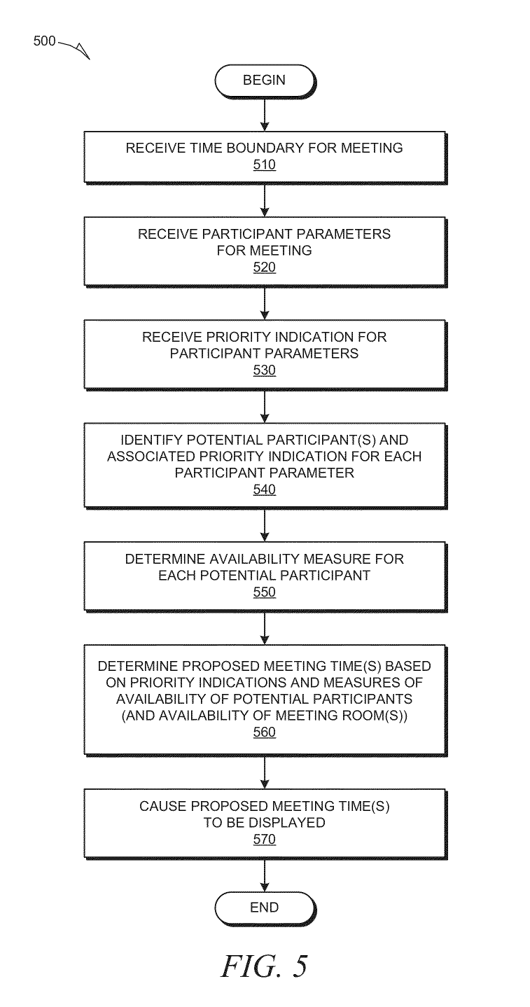

FIG. 5 is a flowchart illustrating a method 500 of organizing a meeting, in accordance with an example embodiment. It is contemplated that the operations of method 500 may be performed by a system or modules of a system (e.g., meeting organizer module 320 in FIG. 3). At operation 510, time boundary information for a meeting may be received. At operation 520, a plurality of participant parameters for the meeting may be received. At operation 530, a corresponding priority indication for each participant parameter may be received. The priority indication may indicate a level of priority of the corresponding participant parameter for the meeting. Different priority indications may indicate different levels of priority. At operation 540, for each participant parameter, at least one potential participant for the meeting may be identified based on the corresponding participant parameter. The corresponding priority indication for each participant parameter may be associated with the potential participant(s) corresponding to that participant parameter. At operation 550, for each potential participant, a corresponding measure of availability may be determined based on the time boundary information of the meeting. At operation 560, at least one proposed meeting time for the meeting may be determined based on the associated priority indications of the potential participants and the corresponding measures of availability of the potential participants. In some embodiments, the availability of a meeting room, as well as other conditions, may also factor into the determination of the proposed meeting time(s), as previously discussed. At operation 570, the proposed meeting time(s) may be caused to be displayed to on a device. It is contemplated that any of the other features described within the present disclosure may be incorporated into method 500.

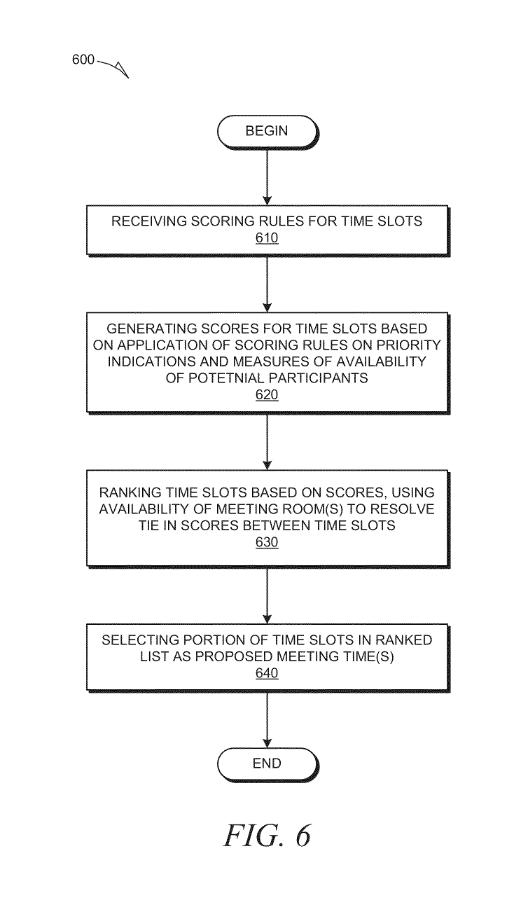

FIG. 6 is a flowchart illustrating a method 600 of determining one or more proposed meeting times, in accordance with an example embodiment. It is contemplated that the operations of method 600 may be performed by a system or modules of a system (e.g., meeting organizer module 320 in FIG. 3). At operation 610, a configuration of scoring rules indicating how to score time slots based on the associated priority indications of the potential participants and the corresponding measures of availability of the potential participants may be received. At operation 620, scores for the time slots may be generated based on an application of the configuration of scoring rules on the associated priority indications of the potential participants and the corresponding measures of availability of the potential participants. At operation 630, the time slots may be ranked based on their corresponding scores. In some embodiments, conditions other than those stemming from the measures of availability for the potential participants may be used to rank the time slots, as previously discussed. For example, in some embodiments, the availability of a meeting room may be used to influence the ranking when two or more time slots have an otherwise equal ranking (e.g., if the measures of availability for the potential participants is the same for both time slots). In some embodiments, if two or more slots have an identical scores, and thus an identical ranking, based on the measures of availability for the potential participants, the tie in scores may be resolve by giving preference to the time slot for which a meeting room is available. Preference may be given to a time slot for which any meeting room is available, a particular meeting room is available, and/or at least one of a particular set of meeting rooms is available. At operation 640, a portion (e.g., top or bottom) of the time slots in the ranked list may be selected as the proposed meeting time(s). It is contemplated that any of the other features described within the present disclosure may be incorporated into method 600.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

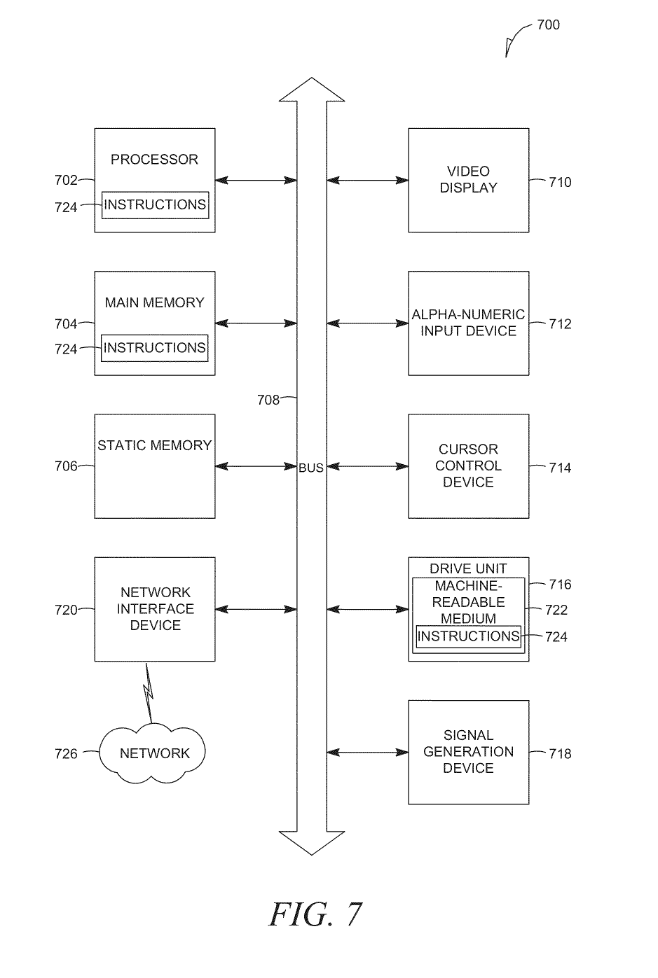

FIG. 7 is a block diagram of a machine in the example form of a computer system 700 within which instructions 724 for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker) and a network interface device 720.

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
receiving time boundary information for a meeting;
receiving a plurality of participant parameters for the meeting;
receiving a corresponding priority indication for each participant parameter, the priority indication indicating a level of priority of the corresponding participant parameter for the meeting, wherein different priority indications indicate different levels of priority;
for each participant parameter, identifying at least one potential participant for the meeting based on the corresponding participant parameter, wherein the corresponding priority indication for each participant parameter is associated with the at least one potential participant corresponding to that participant parameter;
for each potential participant, determining a corresponding measure of availability based on the time boundary information of the meeting; and
determining, by a machine having a memory and at least one processor, at least one proposed meeting time for the meeting based on the associated priority indications of the potential participants and the corresponding measures of availability of the potential participants.

2. The method of claim 1, wherein each participant parameter comprises an identification of a person or an identification of a role within an organization.

3. The method of claim 1, wherein determining the at least one proposed meeting time comprises:
receiving a configuration of scoring rules indicating how to score time slots based on the associated priority indications of the potential participants and the corresponding measures of availability of the potential participants;
generating scores for the time slots based on an application of the configuration of scoring rules on the associated priority indications of the potential participants and the corresponding measures of availability of the potential participants;
ranking the time slots based on their corresponding scores; and
selecting either a top portion or a bottom portion of the ranked time slots as the at least one proposed meeting time.

4. The method of claim 1, further comprising causing the at least one proposed meeting time to be displayed to a user on a device.

5. The method of claim 1, wherein:
at least one of the participant parameters comprises an identification of a role within an organization; and
for the at least one of the participant parameters comprising the identification of the role within the organization, identifying the at least one potential participant for the meeting comprises identifying a plurality of potential role-based participants having the role within the organization.

6. The method of claim 5, wherein determining at least one proposed meeting time is further based on a condition of at least one of the potential role-based participants being available to attend the at least one proposed meeting time.

7. The method of claim 1, wherein determining at least one proposed meeting time is further based on a condition of a minimum number of the potential participants being available to attend the at least one proposed meeting time.

8. The method of claim 1, wherein determining at least one proposed meeting time is further based on a condition of a particular grouping of the potential participants being available to attend the at least one proposed meeting time.

9. The method of claim 1, wherein the at least one proposed meeting time comprises multiple proposed meeting times.

10. The method of claim 1, wherein the at least one proposed meeting time comprises a recurring meeting time.

11. The method of claim 1, wherein the at least one proposed meeting time comprises a date and time slot for the meeting.

12. A system comprising:
a machine having a memory and at least one processor; and
a meeting organizer module on the machine, the meeting organizer module being configured to:
receive time boundary information for a meeting;
receive a plurality of participant parameters for the meeting;
receive a corresponding priority indication for each participant parameter, the priority indication indicating a level of priority of the corresponding participant parameter for the meeting, wherein different priority indications indicate different levels of priority;
for each participant parameter, identify at least one potential participant for the meeting based on the corresponding participant parameter, wherein the corresponding priority indication for each participant parameter is associated with the at least one potential participant corresponding to that participant parameter;
for each potential participant, determine a corresponding measure of availability based on the time boundary information of the meeting; and
determine at least one proposed meeting time for the meeting based on the associated priority indications of the potential participants and the corresponding measures of availability of the potential participants.

13. The system of claim 12, wherein each participant parameter comprises an identification of a person or an identification of a role within an organization.

14. The system of claim 12, wherein determining the at least one proposed meeting time comprises:
receiving a configuration of scoring rules indicating how to score time slots based on the associated priority indications of the potential participants and the corresponding measures of availability of the potential participants;
generating scores for the time slots based on an application of the configuration of scoring rules on the associated priority indications of the potential participants and the corresponding measures of availability of the potential participants;
ranking the time slots based on their corresponding scores; and
selecting either a top portion or a bottom portion of the ranked time slots as the at least one proposed meeting time.

15. The system of claim 12, wherein the meeting organizer module is further configured to cause the at least one proposed meeting time to be displayed to a user on a device.

16. The system of claim 12, wherein:
at least one of the participant parameters comprises an identification of a role within an organization; and
the meeting organizer module is further configured to, for the at least one of the participant parameters comprising the identification of the role within the organization, identify the at least one potential participant for the meeting by identifying a plurality of potential role-based participants having the role within the organization.

17. The system of claim 16, wherein determining at least one proposed meeting time is further based on a condition of at least one of the potential role-based participants being available to attend the at least one proposed meeting time.

18. A non-transitory machine-readable storage device, tangibly embodying a set of instructions that, when executed by at least one processor, causes the at least one processor to perform a set of operations comprising:
receiving time boundary information for a meeting;
receiving a plurality of participant parameters for the meeting;
receiving a corresponding priority indication for each participant parameter, the priority indication indicating a level of priority of the corresponding participant parameter for the meeting, wherein different priority indications indicate different levels of priority;
for each participant parameter, identifying at least one potential participant for the meeting based on the corresponding participant parameter, wherein the corresponding priority indication for each participant parameter is associated with the at least one potential participant corresponding to that participant parameter;
for each potential participant, determining a corresponding measure of availability based on the time boundary information of the meeting; and
determining at least one proposed meeting time for the meeting based on the associated priority indications of the potential participants and the corresponding measures of availability of the potential participants.

19. The device of claim 18, wherein each participant parameter comprises an identification of a person or an identification of a role within an organization.

20. The device of claim 18, wherein determining the at least one proposed meeting time comprises:
receiving a configuration of scoring rules indicating how to score time slots based on the associated priority indications of the potential participants and the corresponding measures of availability of the potential participants;
generating scores for the time slots based on an application of the configuration of scoring rules on the associated priority indications of the potential participants and the corresponding measures of availability of the potential participants;
ranking the time slots based on their corresponding scores; and
selecting either a top portion or a bottom portion of the ranked time slots as the at least one proposed meeting time.
